(19) United States
(12) Patent Application Publication
(10) Pub. No.: US 2026/0037291 A1
(43) Pub. Date: Feb. 5, 2026

(54) TRANSPARENT ENABLEMENT OF LARGE FRAMES FOR SECURE GUESTS

(71) Applicant: INTERNATIONAL BUSINESS MACHINES CORPORATION, Armonk, NY (US)

(72) Inventors: Claudio IMBRENDA, Boeblingen (DE); Fadi Y. BUSABA, Poughkeepsie, NY (US); Christian BORNTRAEGER, Stuttgart (DE); Lisa Cranton HELLER, Rhinebeck, NY (US); Jonathan D. BRADBURY, Poughkeepsie, NY (US); Torsten HENDEL, Holzgerlingen (DE)

(21) Appl. No.: 18/791,755

(22) Filed: Aug. 1, 2024

(51) Int. Cl. G06F 9/455; G06F 21/53

(52) U.S. Cl. CPC G06F 9/45558; G06F 21/53; G06F 2009/45583; G06F 2009/45587

(57) ABSTRACT

Computer program products, computer-implemented method, and computer systems include a trusted element enabling host translation for a large page for a given block of memory of a secure guest. The enabling can include executing, in a trusted computing environment, a call from a host to import a page to a memory of the secure guest. The trusted element can determine that a page virtual address matches a page corresponding absolute address and based on this determination can increase a counter associated with the large page; the counter indicates small pages comprising the large page imported to guest memories. When the counter indicates that all the small pages were imported and based on this determination, the trusted element determines if that all the small pages meet pre-defined security requirements and if they do, enables host translation for the large page for the given block of memory of the secure guest.

### BACKGROUND

One or more aspects relate, in general, to facilitating processing within a computing environment, and in particular, to improving such processing.

Cloud computing and cloud storage provides users with capabilities to store and process their data in third-party data centers. Cloud computing facilitates the ability to provision a virtual machine (VM) for a customer quickly and easily, without requiring the customer to purchase hardware or to provide floor space for a physical server. The customer may easily expand or contract the VM according to changing preferences or requirements of the customer. Typically, a cloud computing provider provisions the VM, which is physically resident on a server at the provider's data center. Customers are often concerned about the security of data in the VM, particularly since computing providers often store more than one customer's data on the same server. Customers may desire security between their own code/data and the cloud computing provider's code/data, as well as between their own code/data and that of other VMs running at the provider's site. In addition, the customer may desire security from the provider's administrators as well as against potential security breaches from other code running on the machine.

To handle such sensitive situations, cloud service providers may implement security controls to ensure proper data isolation and logical storage segregation. The extensive use of virtualization in implementing cloud infrastructure results in unique security concerns for customers of cloud services as virtualization alters the relationship between an operating system (OS) and the underlying hardware, be it computing, storage, or even networking hardware. This introduces virtualization as an additional layer that itself must be properly configured, managed and secured.

In general, a VM, running as a guest under the control of a host hypervisor, relies on that hypervisor to transparently provide virtualization services for that guest. These services include memory management, instruction emulation, and interruption processing. For example, guest memory can be paged out by the host at any time.

In the case of memory management, the VM can move (page-in) its data from a disk to be resident in memory and the VM can also move its data back out (page-out) to the disk. While the page is resident in memory, the VM (guest) uses dynamic address translation (DAT) to map the pages in memory from a guest virtual address to a guest absolute address. In addition, the host hypervisor has its own DAT mapping (from host virtual address to host absolute address) for the guest pages in memory and it can, independently and transparently to the guest, page the guest pages in and out of memory. It is through the host DAT tables that the hypervisor provides memory isolation or sharing of guest memory between two separate guest VMs. The host is also able to access the guest memory to simulate guest operations, when necessary, on behalf of the guest.

A hypervisor or virtual machine manager can control various guests (e.g., virtual machines, virtual servers) with access to system resources. Different guests managed by a common hypervisor can be generated by different owners. Of these guests, some can be secure guests. A traditional hypervisor has full control over all guests hosted. In particular, the hypervisor has the capability to inspect and even modify all memory of the hosted guest. In a cloud environment such a setup requires the hypervisor and its administrators to be fully trustworthy.

A secure guest, which can also be referred to as a secure execution guest) is a guest that can be hosted by hypervisors that are not (fully) trustworthy. The image of such a guest would be protected when loaded and the protection of the contents of the resources assigned to the guest (e.g., memory, CPU registers) would be maintained throughout the lifetime of the guest. The protection of the guest comprises at least integrity protection (e.g., hypervisor cannot maliciously change any guest states) and in addition can comprise maintaining the confidentiality of the initial image and code and data running in the guest. These services can apply to any interface between a secure entity and another untrusted entity that traditionally allows access to the secure resources by this other entity.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include enabling host translation for a large page for a given block of memory of a secure guest. This enabling includes executing, in a trusted computing environment, a call from a host to import a page to a memory of the secure guest, where the secure guest is managed by the host in an untrusted computing environment. Based on executing the import, the enabling includes determining that a page virtual address matches a page corresponding absolute address. Based on determining that there is a match, the enabling includes increasing a counter associated with the large page, where the large page corresponds to the page corresponding absolute address of a small page being imported, where the counter indicates a number of small pages comprising the large page imported to the memory of guests managed by the host. The enabling includes determining that the counter indicates that all the small pages comprising the large page were imported. Based on determining that the counter indicates that all the small pages comprising the large page were imported, the enabling includes determining that all the small pages comprising the large page meet pre-defined security requirements. Based on determining that all the small pages comprising the large page meet the pre-defined security requirements, the enabling includes enabling host translation for the large page for the given block of memory of the secure guest.

Shortcomings of the prior art are overcome, and additional advantages are provided through the provision of a computer-implemented method. The method includes enabling host translation for a large page for a given block of memory of a secure guest. This enabling includes executing, in a trusted computing environment, a call from a host to import a page to a memory of the secure guest, where the secure guest is managed by the host in an untrusted computing environment. Based on executing the import, the enabling includes determining that a page virtual address matches a page corresponding absolute address. Based on determining that there is a match, the enabling includes increasing a counter associated with the large page, where the large page corresponds to the page corresponding absolute address of a small page being imported, where the counter indicates a number of small pages comprising the large page imported to the memory of guests managed by the host. The enabling includes determining that the counter indicates that all the small pages comprising the large page were imported. Based on determining that the counter indicates that all the small pages comprising the large page were imported, the enabling includes determining that all the small pages comprising the large page meet pre-defined security requirements. Based on determining that all the small pages comprising the large page meet the pre-defined security requirements, the enabling includes enabling host translation for the large page for the given block of memory of the secure guest.

Shortcomings of the prior art are overcome, and additional advantages are provided through the provision of a system. The system includes: a memory, one or more processors in communication with the memory, and program instructions executable by the one or more processors via the memory to perform a method. The method includes enabling host translation for a large page for a given block of memory of a secure guest. This enabling includes executing, in a trusted computing environment, a call from a host to import a page to a memory of the secure guest, where the secure guest is managed by the host in an untrusted computing environment. Based on executing the import, the enabling includes determining that a page virtual address matches a page corresponding absolute address. Based on determining that there is a match, the enabling includes increasing a counter associated with the large page, where the large page corresponds to the page corresponding absolute address of a small page being imported, where the counter indicates a number of small pages comprising the large page imported to the memory of guests managed by the host. The enabling includes determining that the counter indicates that all the small pages comprising the large page were imported. Based on determining that the counter indicates that all the small pages comprising the large page were imported, the enabling includes determining that all the small pages comprising the large page meet pre-defined security requirements. Based on determining that all the small pages comprising the large page meet the pre-defined security requirements, the enabling includes enabling host translation for the large page for the given block of memory of the secure guest.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3 depicts one example of a computing environment to incorporate and use one or more aspects of the present disclosure;

FIG. 4 depicts certain components of a computing environment to incorporate and use one or more aspects of the present disclosure;

FIG. 5 is a technical environment that can include various aspects of some embodiments of the present disclosure;

FIG. 6 depicts a workflow comprising various aspects in accordance with one or more aspects of the present disclosure;

FIG. 7 depicts a workflow comprising various aspects in accordance with one or more aspects of the present disclosure;

FIG. 8 depicts a workflow comprising various aspects in accordance with one or more aspects of the present disclosure;

FIG. 9 depicts a workflow comprising various aspects in accordance with one or more aspects of the present disclosure; and

FIGS. 10A-10B depict another example of a computing environment to incorporate and use one or more aspects of the present disclosure.

### DETAILED DESCRIPTION

In various computing architectures, secure (execution) guests (e.g., virtual machines (VMs)) can be managed by a hypervisor or host that is not trusted. Secure execution enables a (secure) guest to execute without being accessible to the host. Although the host cannot view or access unencrypted secure guest data in memory, the host can page memory to both secure and non-secure guests at any time. Because the host is not trusted, the various security properties associated with the secure guests (and secure execution) are enforced by a security interface control, which can comprise both trusted code and hardware components and can comprise, in some examples an Ultravisor (UV). The trusted code components can be millicode, which is internal code that can be utilized to implements functions in a computing system (e.g., a high level microcode utilized to implement an instruction set in a machine). Because of the complexity of managing secure guests, as opposed to non-secure guests, in existing virtual machine management approaches, page sizes allocated by the host to the secure guests were limited. In one environment, which is provided for illustrative purposes and non-limiting, secure guests could only be backed by small (e.g., 4 k) pages in the host. Meanwhile, non-secure guests could be allotted both small pages as well as large pages. The host could allot large pages to non-secure guests (while allotting small pages to both secure and non-secure guests) because the complexities associated with managing secure guests based on allotting pages with an untrusted entity introduced potential processing delays and could impact the general performance of the computing system. Rather than navigate these delays, in some computing environments, existing approaches prevent secure guests from being backed by large pages. An attempt by a requestor to call a hypervisor to back a secure guest with a large page would cause the hardware and/or millicode of the security interface control to return an exception to the source of the call. Because of the implementation concerns (e.g., security and performance), certain benefits of utilizing larger pages could not be realized with existing approaches. For example, larger pages allow for more efficient and faster address translation, promote fewer cache misses, and reduce system overhead (when compared to smaller pages).

One way in which some computing systems validate secure guest memory is by utilizing a table. This table can include host virtual to absolute mappings. Mappings can be contiguous in memory and indexed in this table by host absolute address. An example of a computing system that utilizes a table in this manner is the z/Architecture instruction set architecture that is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities may include and/or use one or more aspects of the present invention. z/Architecture and IBM are trademarks or registered trademarks of International Business Machines Corporation in at least one jurisdiction. This architecture example utilizes a table referred to as a secure execution identifier (SEID) table (also referred to as SEIDT). The use of this table, or an architecture that includes a table, in its current configuration, for this type of mapping, can create performance losses based on a loss of locality. For example, when two adjacent guest pages are mapped to two distinct host pages (potentially far away from each other), each access yields two distinct table accesses. Accessing distant entries can lead to cache misses because when accessing two blocks next to each other, whether a guest is secure of not, there is regular access overhead, but with the secure guest there is additional overhead because one accesses table entries to guarantee the security properties. Hence, in the examples herein, certain conditions are created in advance such that secure guests can be backed with larger pages but because these conditions are satisfied in advance of backing the secure guest with the larger page, the potential additional overhead cost is minimized.

In the examples herein, to enable secure guests to be backed with larger pages, elements of the computing architecture are modified. To enable backing secure guests with large pages, a secure interface control (e.g., an Ultravisor comprising millicode and/or firmware) maintains a table and/or other value storage structure that includes an entry for each large frame. The value in these examples is a counter and when the counter indicates that that every small page comprising a large frame belongs to the same guest, provided that all the guest pages in the block (which will be backed by the host) are imported into the guest and correctly aligned in absolute memory, the secure guest can be backed utilizing the large page. In these examples, the secure interface control transparently enables the host to utilize large pages to back secure guests because the timing of enabling this feature is when the host attempts to import pages (e.g., an import Ultravisor calls (UVC)) and the timing of disabling this feature is when the host attempts to export pages (e.g., an export UVC). Hence, the host does not issue any new or specialized calls or commands (e.g., UVCs), so enabling and disabling this feature is transparent to the guest and is presented in a way that is transparent to the host memory management. The functionality is handled by the secure interface control when the host attempts to import and/or export pages.

This transparent approach for enabling and disabling the backing of secure guests with large pages will be described as well as illustrated in greater detail herein. In general, in some of the examples herein, a secure interface control (which is trusted) can store table information about possible large pages/frames of the memory of the secure guest in a translation table. When this secure interface control receives a request from a host (which is untrusted and can be understood as a hypervisor) to import a page or a frame to the memory of a secure guest, the secure interface control checks if a page virtual (guest) address matches with a page corresponding absolute (host) address. If there is a match, the secure interface control increases a value of a counter of a corresponding large page. The secure interface control then checks the counter value to determine if all pages of this large page and/or frame are imported. When the secure interface control determines that all pages of this large page and/or frame were imported, i.e., that they belong to the same secure guest and that all the imported (small) pages belong to the same large page and/or frame of the secure guest, the secure interface control enables large page and/or frame translations utilizing this large page (e.g., by hardware comprising the secure interface control) for a specified block of memory of this secure guest.

In the examples herein, a secure interface control maintains an additional state indicator. As will be described herein, the secure interface control can maintain this state using a counter. Whenever a page is imported into a guest that did not belong to the guest but now belongs to the guest (e.g., a new page that guest had not used before or a page was swapped out so it is now being swapped back in), the secure interface control performs a check to see if the page index is the correct one (e.g., index in the virtual memory is the same offset as the host absolute memory) and if it is in the right position within the large (e.g., 1M) block, the secure control interface increases the counter. In some examples, there is a counter for each large frame. Once a counter indicates that every page (e.g., small pages or frames in the large frame) belongs to a guest and is correctly aligned, the secure interface control can check any remaining properties and if that check is successful, the secure interface control enables large frame backing by the host utilizing the large frame associated with the counter.

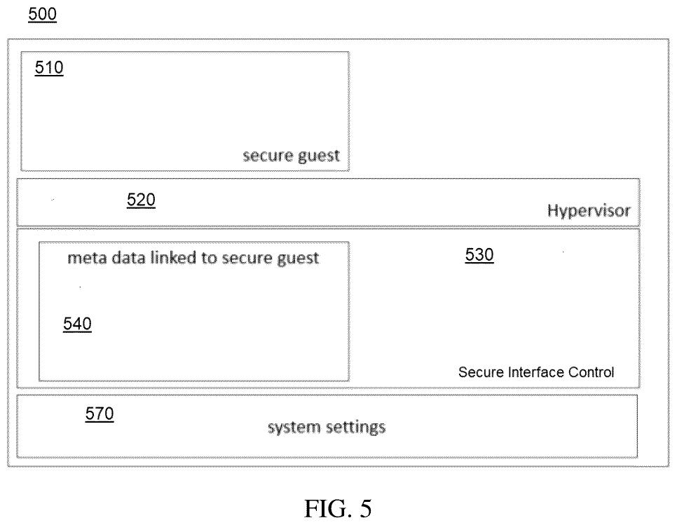

The computer-implemented methods, computer program products, and computer systems described herein facilitate more efficient processing within a computing environment by enabling a host (including an untrusted host, a VM manager such as a hypervisor, etc.) to back secure guests (secure VMs), with large frames or pages. Although a block of central storage is sometimes referred to as a frame and a block of virtual storage sometimes referred to as a page, these terms can be used interchangeably to designate blocks of memory and they are used interchangeably herein. As described in greater detail herein, enabling the backing of secure guests with large pages can be accomplished by introducing additional fields and/or tables to allow a secure interface control (e.g., FIG. 5, 530) in a computing environment to save, increment, and decrement a counter associated with each large memory page. In these examples, the secure interface control can enable this feature in a transparent manner because it implements this functionality when the host is engaged in the regular activity of importing pages for use in backing guests. Hence, the implementation is transparent to the guest and is presented in a way that is transparent to the host memory management.

The examples here also include computer-implemented methods, computer program products, and computer systems to break the large frames that were previously allotted for backing secure guests, such that the large host from cannot be utilized to back a large guest frame of a secure guest. This process can be referred to as breaking the frame. Just as the secure interface control enables the host to back secure guests with large pages in a manner that is transparent to the guest and to the host memory management, the secure control interface likewise disables this functionality (e.g., breaks the frame) in a manner transparent to the guest and to the host memory management as the secure interface control disables this functionality for a given large frame when a host is engaged in the regular activity of exporting pages used for backing guests. Just as the secure interface control incremented the counter to eventually indicate that all small frames comprising a large frame were imported (and met the other conditions described above) before they could be utilized to back a secure guest, the secure interface control can change the security properties of a large page by decrementing its counter. In these examples, the requestor, which is the host or hypervisor, cannot change the security properties of the frames and/or pages because this host is not trusted. Thus, when the host attempts to export a page that is part of a large frame that is currently available to back a given secure guest, the secure interface control, which is trusted, checks if the page virtual address matches with the page corresponding absolute address, to determine if there should be a decrease in the counter of a corresponding large page and/or frame. The secure interface control checks, based on the counter, if all pages of the large page and/or frame were previously imported. When the conditions that enabled the backing of the secure guests with the large pages no longer exist, meaning that the small pages comprising the large page are no longer imported and all associated with the same secure guest, the secure interface control then disallows (e.g., utilizing hardware) backing with this large page, for a specified block of memory of the secure guest. Hence, the counter for each respective large page is an indicator that causes the secure interface control to allow or disallow the host to back secure guests with the respective large page.

The examples herein include computer program products that include a set of one or more computer-readable storage media and program instructions, collectively stored in the set of one or more computer-readable storage media, for causing at least one computing device to perform computer operations. The operations include enabling host translation for a large page for a given block of memory of a secure guest. This enabling includes executing, in a trusted computing environment, a call from a host to import a page to a memory of the secure guest, where the secure guest is managed by the host in an untrusted computing environment. Based on executing the import, the enabling includes determining that a page virtual address matches a page corresponding absolute address. Based on determining that there is a match, the enabling includes increasing a counter associated with the large page, where the large page corresponds to the page corresponding absolute address of a small page being imported, where the counter indicates a number of small pages comprising the large page imported to the memory of guests managed by the host. The enabling includes determining that the counter indicates that all the small pages comprising the large page were imported. Based on determining that the counter indicates that all the small pages comprising the large page were imported, the enabling includes determining that all the small pages comprising the large page meet pre-defined security requirements. Based on determining that all the small pages comprising the large page meet the pre-defined security requirements, the enabling includes enabling host translation for the large page for the given block of memory of the secure guest. Enabling backing secure guests with large pages allows the system to realize the processing advantages of utilizing large pages to back secure guests, including faster name translation, without the negative impacts on processing (cache misses, processing speed, overhead, etc.). This enabling is done transparently, from the point of view of the guest and is presented in a way that is transparent to the host memory management, and limits impacts on processing by setting aside minimal additional memory for the counter.

Alternatively or additionally, the secure guest comprises a virtual machine. The use of virtual machines in a computing environment diversifies the processing capabilities of the computing system.

Alternatively or additionally, the host comprises a hypervisor. A hypervisor can apportion absolute memory to virtual machines, allowing the environment to utilize its resources efficiently. Meanwhile, the hypervisor maintains the security of secure guests operating in the environment.

Alternatively or additionally, the computer operations can include storing in a computing element, a designation identifying the large page as being enabled for the translation. Storing this value provides a light weight designation to enable backing of secure guests with a particular large page.

Alternatively or additionally, the computing element is selected from the group consisting of: a bitmap and a table. A computer program product can utilize a bit map or a table value as an approach, with minimal impact to overhead, to enable a secure interface control to provide a response to a host regarding whether a large page can be utilized to back a secure guest, increasing the processing speed of the computing system.

Alternatively or additionally, the computer operations can include, during runtime of an additional secure guest, checking a designation for another page to identify whether the other page is enabled for use as a large page for host translation for the given block of memory of the additional secure guest. Based on identifying that the corresponding large page is not enabled for the translation, the operations can include generating an exception to inform the host of a page mismatch. This exception enables a communication between the host and the secure interface control because based on receiving this exception, the host knows the guest is secure, and can seek a different avenue to enable it to back this secure guest with a large page.

Alternatively or additionally, the operations can include obtaining, from the host, one or more requests to import each small page comprising the corresponding large page. This action represents a different avenue that the cost can use to back this secure guest with a large page and realize the processing advantages of using a large page.

Alternatively or additionally, the translation for the large page for the given block of memory of the secure guest is performed by hardware in trusted computing environment. Utilizing hardware in a trusted environment to perform this translation maintains the security of the trusted environment while still allowing the host to allocate large pages to secure guests, when appropriate.

Alternatively or additionally, the computer operations can include determining that all small pages comprising the large page and the large page meet pre-defined security requirements. This determination can include that for each small page of the large page, determining that the page is owned by a common guest owner with all other small pages of the large page, and determining that the page is located within a common large page. Previous allocation approaches did not enable a host to back a secure guest with large pages because of the overhead and processing load involved in determining if a page can be allocated. This approach checks certain properties in advance so that the processing efficiencies of the computing system are not negatively impacted by enabling backing of secure guests with large pages.

Alternatively or additionally, the computer operations can include maintaining, in a trusted computing environment, an entry for each large page of memory, where for each large page, the entry comprises the counter. Utilizing a counter, which utilizes negligible additional memory, enables hosts to back secure guests with large pages without trading off processing efficiencies.

Alternatively or additionally, the computer operations can include executing a call from the host to export a given small page of the small pages comprising the large page. The computer operations can include determining that a page virtual address for the given small page matches a page corresponding absolute address for the given small page. The computer operations can include determining if all the small pages comprising the large page were imported. Based on determining that not all the small pages comprising the large page were imported, the computer operations can include decreasing the counter to reflect exporting the given small page. A process for disabling guest backing with a given large page is performed transparently, from the point of view of the guest and is presented in a way that is transparent to the host memory management, and limits impacts on processing by setting aside minimal additional memory for the counter and maintains processing consistency because performing the disabling is done in the normal course of processing (e.g., at export). In this example, the criteria was not met for the export to trigger disabling of the functionality, but this example demonstrates the continuity that can be maintained even as a facility to disable is a possibility.

Alternatively or additionally, the computer operations can include executing a call from the host to export a given small page of the small pages comprising the large page. The operations can include determining that a page virtual address for the given small page matches a page corresponding absolute address for the given small page. The operations can include determining if all the small pages comprising the large page were imported. Based on determining that all the small pages comprising the large page were imported, the operations can include decreasing the counter to reflect exporting the given small page and disabling host translation for the large page for the given block of memory of the secure guest. This disabling is done transparently, from the point of view of the guest and is presented in a way that is transparent to the host memory management, and limits impacts on processing by setting aside minimal additional memory for the counter and maintains processing consistency because performing the disabling is done in the normal course of processing (e.g., at export).

Alternatively or additionally, disabling host translation for the large page for the given block of memory of the secure guest can comprise updating, in a computing element, a designation associated with the large page. The use of this element is a light weight designation to disable backing of secure guests with a particular large page.

Disclosed herein are computer-implemented methods that include enabling host translation for a large page for a given block of memory of a secure guest. This enabling includes executing, in a trusted computing environment, a call from a host to import a page to a memory of the secure guest, where the secure guest is managed by the host in an untrusted computing environment. Based on executing the import, the enabling includes determining that a page virtual address matches a page corresponding absolute address. Based on determining that there is a match, the enabling includes increasing a counter associated with the large page, where the large page corresponds to the page corresponding absolute address of a small page being imported, where the counter indicates a number of small pages comprising the large page imported to the memory of guests managed by the host. The enabling includes determining that the counter indicates that all the small pages comprising the large page were imported. Based on determining that the counter indicates that all the small pages comprising the large page were imported, the enabling includes determining that all the small pages comprising the large page meet pre-defined security requirements. Based on determining that all the small pages comprising the large page meet the pre-defined security requirements, the enabling includes enabling host translation for the large page for the given block of memory of the secure guest. Enabling backing secure guests with large pages allows the system to realize the processing advantages of utilizing large pages to back secure guests, including faster name translation, without the negative impacts on processing (cache misses, processing speed, overhead, etc.). This enabling is done transparently, from the point of view of the guest and is presented in a way that is transparent to the host memory management, and limits impacts on processing by setting aside minimal additional memory for the counter.

Alternatively or additionally, the secure guest comprises a virtual machine. The use of virtual machines in a computing environment diversifies the processing capabilities of the computing system.

Alternatively or additionally, the host comprises a hypervisor. A hypervisor can apportion absolute memory to virtual machines, allowing the environment to utilize its resources efficiently. Meanwhile, the hypervisor maintains the security of secure guests operating in the environment.

Alternatively or additionally, the method can include storing in a computing element, a designation identifying the large page as being enabled for the translation. Storing this value provides a light weight designation to enable backing of secure guests with a particular large page.

Alternatively or additionally, the computing element is selected from the group consisting of: a bitmap and a table. A computer program product can utilize a bit map or a table value as an approach, with minimal impact to overhead, to enable a secure interface control to provide a response to a host regarding whether a large page can be utilized to back a secure guest, increasing the processing speed of the computing system.

Alternatively or additionally, the method can include executing, in a trusted computing environment, an additional call from a host to import another page to a memory of the secure guest. The method can also include, based on executing the import, determining if a page virtual address for the other page matches a page corresponding absolute address for the other page. Additionally, the method can include checking a designation for the other page to identify whether a corresponding large page is enabled for the translation. Finally, based on identifying that the corresponding large page is not enabled for the translation, the method can include generating an exception to inform the host of a page mismatch. This exception enables a communication between the host and the secure interface control because based on receiving this exception, the host knows the guest is secure, and can seek a different avenue to enable it to back this secure guest with a large page.

Alternatively or additionally, the method can include obtaining, from the host, one or more requests to import each small page comprising the corresponding large page. This action represents a different avenue that the cost can use to back this secure guest with a large page and realize the processing advantages of using a large page.

Alternatively or additionally, the translation for the large page for the given block of memory of the secure guest is performed by hardware in trusted computing environment. Utilizing hardware in a trusted environment to perform this translation maintains the security of the trusted environment while still allowing the host to allocate large pages to secure guests, when appropriate.

Alternatively or additionally, the method can include determining that all small pages comprising the large page and the large page meet pre-defined security requirements. This determination can include that for each small page of the large page, determining that the page is owned by a common guest owner with all other small pages of the large page, and determining that the page is located within a common large page. Previous allocation approaches did not enable a host to back a secure guest with large pages because of the overhead and processing load involved in determining if a page can be allocated. This approach checks certain properties in advance so that the processing efficiencies of the computing system are not negatively impacted by enabling backing of secure guests with large pages.

Alternatively or additionally, the method can include maintaining, in a trusted computing environment, an entry for each large page of memory, where for each large page, the entry comprises the counter. Utilizing a counter, which utilizes negligible additional memory, enables hosts to back secure guests with large pages without trading off processing efficiencies.

Alternatively or additionally, the method can include executing a call from the host to export a given small page of the small pages comprising the large page. The method can include determining that a page virtual address for the given small page matches a page corresponding absolute address for the given small page. The method can include determining if all the small pages comprising the large page were imported. Based on determining that not all the small pages comprising the large page were imported, the method can include decreasing the counter to reflect exporting the given small page. A process for disabling guest backing with a given large page is performed transparently, from the point of view of the guest and is presented in a way that is transparent to the host memory management, and limits impacts on processing by setting aside minimal additional memory for the counter and maintains processing consistency because performing the disabling is done in the normal course of processing (e.g., at export). In this example, the criteria was not met for the export to trigger disabling of the functionality, but this example demonstrates the continuity that can be maintained even as a facility to disable is a possibility.

Alternatively or additionally, the method can include executing a call from the host to export a given small page of the small pages comprising the large page. The method can include determining that a page virtual address for the given small page matches a page corresponding absolute address for the given small page. The method can include determining if all the small pages comprising the large page were imported. Based on determining that all the small pages comprising the large page were imported, the method can include decreasing the counter to reflect exporting the given small page and disabling host translation for the large page for the given block of memory of the secure guest. This disabling is done transparently, from the point of view of the guest and is presented in a way that is transparent to the host memory management, and limits impacts on processing by setting aside minimal additional memory for the counter and maintains processing consistency because performing the disabling is done in the normal course of processing (e.g., at export).

Alternatively or additionally, disabling host translation for the large page for the given block of memory of the secure guest can comprise updating, in a computing element, a designation associated with the large page. The use of this element is a light weight designation to disable backing of secure guests with a particular large page.

Disclosed herein are computer systems that include at least one computing device. The systems include a set of one or more computer-readable storage media. The computer system include program instructions, collectively stored in the set of one or more computer-readable storage media, for causing the at least one computing device to perform computer operations. In some examples, these operations include enabling host translation for a large page for a given block of memory of a secure guest. This enabling includes executing, in a trusted computing environment, a call from a host to import a page to a memory of the secure guest, where the secure guest is managed by the host in an untrusted computing environment. Based on executing the import, the enabling includes determining that a page virtual address matches a page corresponding absolute address. Based on determining that there is a match, the enabling includes increasing a counter associated with the large page, where the large page corresponds to the page corresponding absolute address of a small page being imported, where the counter indicates a number of small pages comprising the large page imported to the memory of guests managed by the host. The enabling includes determining that the counter indicates that all the small pages comprising the large page were imported. Based on determining that the counter indicates that all the small pages comprising the large page were imported, the enabling includes determining that all the small pages comprising the large page meet pre-defined security requirements. Based on determining that all the small pages comprising the large page meet the pre-defined security requirements, the enabling includes enabling host translation for the large page for the given block of memory of the secure guest. Enabling backing secure guests with large pages allows the system to realize the processing advantages of utilizing large pages to back secure guests, including faster name translation, without the negative impacts on processing (cache misses, processing speed, overhead, etc.). This enabling is done transparently, from the point of view of the guest and is presented in a way that is transparent to the host memory management, and limits impacts on processing by setting aside minimal additional memory for the counter.

Alternatively or additionally, the secure guest comprises a virtual machine. The use of virtual machines in a computing environment diversifies the processing capabilities of the computing system.

Alternatively or additionally, the host comprises a hypervisor. A hypervisor can apportion absolute memory to virtual machines, allowing the environment to utilize its resources efficiently. Meanwhile, the hypervisor maintains the security of secure guests operating in the environment.

Alternatively or additionally, the computer operations can include storing in a computing element, a designation identifying the large page as being enabled for the translation. Storing this value provides a lightweight designation to enable backing of secure guests with a particular large page.

Alternatively or additionally, the computing element is selected from the group consisting of: a bitmap and a table. A computer program product can utilize a bit map or a table value as an approach, with minimal impact to overhead, to enable a secure interface control to provide a response to a host regarding whether a large page can be utilized to back a secure guest, increasing the processing speed of the computing system.

Alternatively or additionally, the computer operations can include, during runtime of an additional secure guest, checking a designation for another page to identify whether the other page is enabled for use as a large page for host translation for the given block of memory of the additional secure guest. Based on identifying that the corresponding large page is not enabled for the translation, the operations can include generating an exception to inform the host of a page mismatch. This exception enables a communication between the host and the secure interface control because based on receiving this exception, the host knows the guest is secure, and can seek a different avenue to enable it to back this secure guest with a large page.

Alternatively or additionally, the operations can include obtaining, from the host, one or more requests to import each small page comprising the corresponding large page. This action represents a different avenue that the cost can use to back this secure guest with a large page and realize the processing advantages of using a large page.

Alternatively or additionally, the translation for the large page for the given block of memory of the secure guest is performed by hardware in trusted computing environment. Utilizing hardware in a trusted environment to perform this translation maintains the security of the trusted environment while still allowing the host to allocate large pages to secure guests, when appropriate.

Alternatively or additionally, the computer operations can include determining that all small pages comprising the large page and the large page meet pre-defined security requirements. This determination can include that for each small page of the large page, determining that the page is owned by a common guest owner with all other small pages of the large page, and determining that the page is located within a common large page. Previous allocation approaches did not enable a host to back a secure guest with large pages because of the overhead and processing load involved in determining if a page can be allocated. This approach checks certain properties in advance so that the processing efficiencies of the computing system are not negatively impacted by enabling backing of secure guests with large pages.

Alternatively or additionally, the computer operations can include maintaining, in a trusted computing environment, an entry for each large page of memory, where for each large page, the entry comprises the counter. Utilizing a counter, which utilizes negligible additional memory, enables hosts to back secure guests with large pages without trading off processing efficiencies.

Alternatively or additionally, the computer operations can include executing a call from the host to export a given small page of the small pages comprising the large page. The computer operations can include determining that a page virtual address for the given small page matches a page corresponding absolute address for the given small page. The computer operations can include determining if all the small pages comprising the large page were imported. Based on determining that not all the small pages comprising the large page were imported, the computer operations can include decreasing the counter to reflect exporting the given small page. A process for disabling guest backing with a given large page is performed transparently, from the point of view of the guest and is presented in a way that is transparent to the host memory management, and limits impacts on processing by setting aside minimal additional memory for the counter and maintains processing consistency because performing the disabling is done in the normal course of processing (e.g., at export). In this example, the criteria was not met for the export to trigger disabling of the functionality, but this example demonstrates the continuity that can be maintained even as a facility to disable is a possibility.

Alternatively or additionally, the computer operations can include executing a call from the host to export a given small page of the small pages comprising the large page. The operations can include determining that a page virtual address for the given small page matches a page corresponding absolute address for the given small page. The operations can include determining if all the small pages comprising the large page were imported. Based on determining that all the small pages comprising the large page were not imported, the operations can include decreasing the counter to reflect exporting the given small page and disabling host translation for the large page for the given block of memory of the secure guest. This disabling is done transparently, from the point of view of the guest and is presented in a way that is transparent to the host memory management, and limits impacts on processing by setting aside minimal additional memory for the counter and maintains processing consistency because performing the disabling is done in the normal course of processing (e.g., at export).

Alternatively or additionally, disabling host translation for the large page for the given block of memory of the secure guest can comprise updating, in a computing element, a designation associated with the large page. The use of this element is a light weight designation to disable backing of secure guests with a particular large page.

The examples herein are inextricably tied to computing and are directed to a practical application. Backing VMs with memory and executing secure and non-secure VMs is a functionality that exists only within a computing environment. Furthermore, the practical application addressed herein is enabling the use of large frames for secure guests in a manner that lessens negative impacts on processing (cache misses, processing speed, overhead, etc.) while taking advantage of this functionality within the limitations of secure execution. The approach disclosed herein includes setting aside additional memory for a table and utilizing hardware comprising the secure interface control to update values in the table. The values impact whether a secure interface control (e.g., millicode and/or firmware) enables a host to back secure guests with large pages. Much if not all of the functionality described herein to enable the practical application resides in firmware. Thus, the examples disclosed herein are inextricably tied to computing at least because they are directed to a practical application of addressing an issue unique to computing environments with an approach that utilizes aspects of the computing environment.

The examples herein provide significantly more than other approaches. As aforementioned, in some systems, backing secure guests with large pages is not permitted because of negative impacts on processing, efficiency, and overhead. The examples discussed herein provide the desired functionality without these adverse impacts. For example, although the counters utilize additional memory (so more memory is set aside), the amount is minimal (e.g., a small counter for each large page) and performance benefits are realized by utilizing this additional memory without adverse impacts on the performance of the computing system.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs control mode processing including selective control mode processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

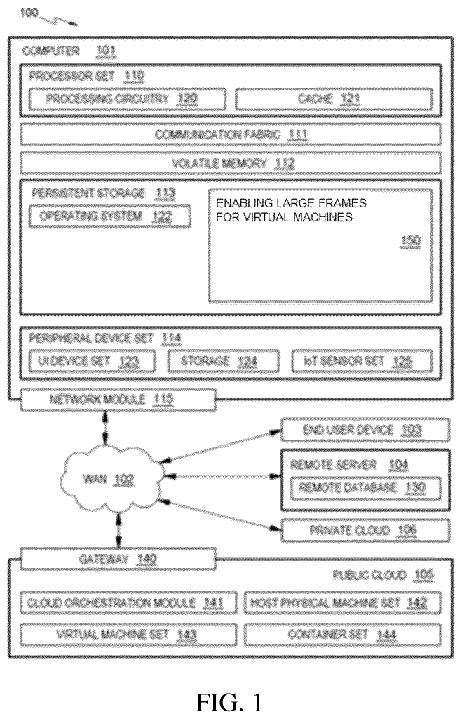

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as enabling large frames for secure VMs150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

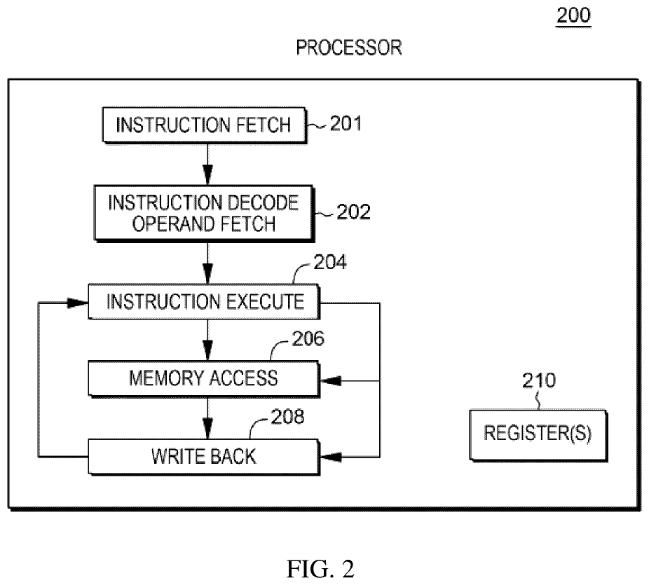

In one example, a processor (e.g., of processor set 110) includes a plurality of functional components (or a subset thereof) used to execute instructions. As depicted in FIG. 2, in one example, a processor 200 includes, for instance, an instruction fetch component 201 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use processing code to generate and return an instruction's firmware code level 150. Additionally, fewer, and/or other components may be used in one or more aspects of the present disclosure.

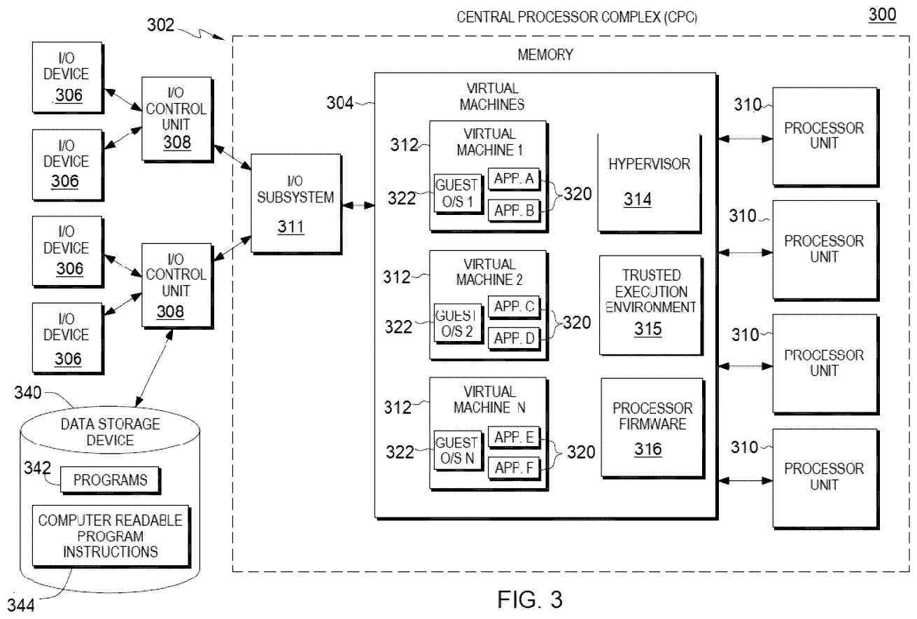

One embodiment of a computing environment to incorporate and use one or more aspects of the present invention is described with reference to FIG. 3. This computing environment was selected for inclusion based on the depictions of virtual machines as part of the technical architecture. As an example, this computing environment can be based on the z/Architecture® instruction set architecture, offered by International Business Machines Corporation, Armonk, New York.

Referring to FIG. 3, in one example, a computing environment 300 includes a central processor complex (CPC) 302. Central processor complex 302 is, for instance, an IBM Z® server (or other server or machine offered by International Business Machines Corporation or other entities) and includes a plurality of components, such as, for instance, a memory 304 (a.k.a., system memory, main memory, main storage, central storage, storage) coupled to one or more processor units (also referred to as processors) 310 and to an input/output (I/O) subsystem 311. Example processor units 310 include one or more general-purpose processors (a.k.a., central processors or central processing units (CPUs)) and/or one or more other processors. IBM Z is a trademark or registered trademark of International Business Machines Corporation in at least one jurisdiction.

I/O subsystem 311 can be a part of the central processor complex or separate therefrom. It directs the flow of information between main storage 304 and input/output control units 308 and input/output (I/O) devices 306 coupled to the central processor complex.

Many types of I/O devices may be used. One particular type is a data storage device 340. Data storage device 340 can store one or more programs 342, one or more computer readable program instructions 344, and/or data, etc. The computer readable program instructions can be configured to carry out functions of embodiments of aspects of the invention.

Central processor complex 302 can include and/or be coupled to removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with central processor complex 302. Examples include, but are not limited to: microcode or millicode, device drivers, redundant processing units, external disk drive arrays, RAID systems, tape drives, and data archival storage systems, etc.

Further, central processor complex 302 can be operational with numerous other general-purpose or special-purpose computing system environments or configurations. Examples of well-known computing systems, environments, and/or configurations that may be suitable for use with central processor complex 302 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Central processor complex 302 provides, in one or more embodiments, virtualization support, in which memory 304 includes, for example, one or more virtual machines 312 (also referred to as guests), a virtual machine manager, such as a hypervisor 314, that manages the virtual machines, a trusted execution environment 315 (also referred to as an Ultravisor) and processor firmware 316. One example of hypervisor 314 is the z/VM® hypervisor, offered by International Business Machines Corporation, Armonk, New York. The hypervisor is sometimes referred to as a host. z/VM is a trademark or registered trademark of International Business Machines Corporation in at least one jurisdiction.

In one or more embodiments, trusted execution environment 315 may be implemented, at least in part, in hardware and/or firmware configured to perform, for instance, processes such as described herein. The trusted execution environment is trusted firmware and/or hardware that makes use of memory-protection hardware to enforce memory protection. The owner of a guest can securely pass information (using, e.g., IBM Secure Execution) to the trusted execution environment by using a public host key, which is embedded in a host key document. To process the confidential information, the trusted execution environment uses a matching private host key. The private host key is specific to the server, e.g., the IBM Z® server, and is hardware protected.

Processor firmware 316 includes, e.g., the microcode or millicode of a processor. It includes, for instance, the hardware-level instructions and/or data structures used in implementation of higher-level machine code. In one embodiment, it includes, for instance, proprietary code that is typically delivered as microcode or millicode that includes trusted software, microcode or millicode specific to the underlying hardware and controls operating system access to the system hardware.

The virtual machine support of the central processor complex provides the ability to operate large numbers of virtual machines 312, each capable of operating with different programs 320 and running a guest operating system 122, such as the Linux® operating system. Each virtual machine 312 is capable of functioning as a separate system. That is, each virtual machine can be independently reset, run a guest operating system, and operate with different programs. An operating system or application program running in a virtual machine appears to have access to a full and complete system, but in reality, only a portion of it is available. Although z/VM and Linux are offered as examples, other virtual machine managers and/or operating systems may be used in accordance with one or more aspects of the present invention. The registered trademark Linux® is used pursuant to a sublicense from the Linux Foundation, the exclusive licensee of Linus Torvalds, owner of the mark on a worldwide basis.

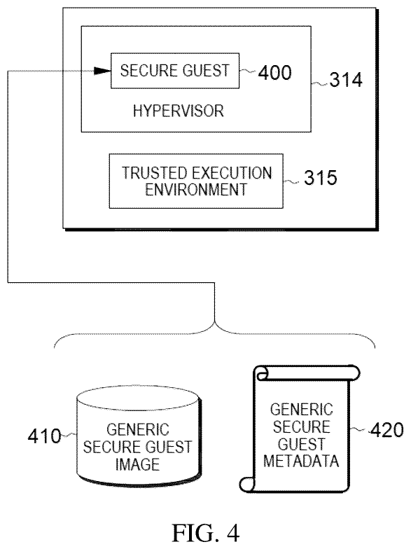

In one embodiment, one or more guests 312 are secure guests. Referring to FIG. 4, a secure guest 400 is started by a hypervisor (e.g., hypervisor 314) in a manner that the hypervisor cannot observe the state (e.g., memory, registers, etc.) of the secure guest. For instance, in one embodiment of confidential computing, the hypervisor can start/stop a secure guest, and the hypervisor knows where data used to start the secure guest is located but it cannot look into the running secure guest. Data used to load/start the secure guest may be encrypted in a manner that the hypervisor cannot see the secure guest. The owner of the secure guest image places confidential data in the secure guest metadata and then generates a secure guest image together with the secure guest metadata. After the secure guest is loaded, any interaction with the state of the secure guest is processed by a trusted execution environment, such as trusted execution environment 315.

In one embodiment, to start a secure guest, the hypervisor passes a secure guest image 410 that the hypervisor previously loaded into memory and secure guest metadata 420 to trusted execution environment 315. The metadata is integrity and at least partially confidentially protected and is only interpreted by the trusted execution environment. Based on the information in the secure guest metadata, the trusted execution environment can then enforce the integrity of the secure guest image loaded into memory, protect the memory of the secure guest containing the loaded image from being accessible by the hypervisor, and potentially decrypt the secure guest image before starting the secure guest.

In the examples herein, secure guests, also referred to as secure execution guests, run virtualized under a hypervisor (e.g., a kernel virtual machine (KVM) hypervisor, which is part of a Linux kernel). The KVM hypervisor is a non-limiting example of a hypervisor or host that can be utilized in the examples herein. The hypervisor (e.g., host) can page out guest memory at any time. The hypervisor is untrusted while a secure interface control, which can be an Ultravisor (UV) is a secure entity (e.g., hardware and/or millicode) and enforces security properties of the secure guests.

FIG. 5 is a technical environment 500 that can include various aspects of some embodiments of the present disclosure. The components that comprise the technical environment 500 of FIG. 5 illustrate how a secure interface control enables a guest owner to control functionality of a guest image, via encryption unique to each owner, and the secure interface control enables/disables a secure guest, based on a given image, to execute in particular host environments. In this example, for Secure Execution, a secure guest 510 is cryptographically linked to metadata 540, which is securely communicated to a secure interface control 530 (e.g., trusted firmware, trusted component, etc.), based on a private host key which is accessible to the secure interface control 530, only. The owner of the secure guest 510 controls the secure interface control 530 allowing or prohibiting execution of the secure guest 510, based on environmental constraints imposed by the owner. For example, the environmental constraints imposed by the owner, through the secure interface control 530, could limit execution of a secure guest in a host system configured to do hardware measurements and/or on a host system configured to use a non-system specific host key. In some embodiments of the present invention, the key to encrypt portions of the metadata is derived using a private key that is only accessible to the secure interface control 530. The secure interface control 530 can also monitor the system settings 570 during runtime, so that the secure interface control 530 can cause the hypervisor 520 to terminate the secure guest 510, if and when the system settings 570 change such that the controls 560 no longer indicate that the secure guest 510 is compatible with the technical environment 500.

As noted above, a secure guest 510 (e.g., virtual machine, virtual server) is controlled by a hypervisor 520 (e.g., virtual machine manager). The secure interface control 550 can obtain, from an owner of the secure guest 510, via the hypervisor 520, metadata associated with the secure guest 540. In some embodiments of the present invention, the metadata 540 is cryptographically linked to the boot image of the secure guest 510. The metadata 540 need not be accessible to the secure guest 510, itself. The metadata 540 can be linked to the image of the secure guest 510. In some embodiments of the present invention, the metadata 540 is cryptographically linked to a guest (e.g., contains a signature of the guest image) so metadata of one guest cannot be misused as metadata of another guest. The metadata 540 can be transferred (e.g., independently, through a secure channel) to the secure interface control 530 such that it is integrity and confidentiality protected.

The examples herein include computer-implemented methods, computer program products, and computer systems that enable a secure interface control to back a secure guest with a large page or frame in a manner that is in keeping with the security protocols and guarantees of secure execution. Maintaining the processing efficiencies and security of the computing environment while enabling this functionality includes checking that certain properties are present before enabling a secure guest to utilize a large frame or page. First, the secure interface control 530 determines that the small pages in the large frame which the hypervisor or host will utilize to back the secure guest is imported (e.g., in secure memory) and that all the small pages belong to the same guest. As discussed in this disclosure, a large frame is comprised of smaller frames, for example, a large frame, which can be 1M (or smaller or larger than 1M), and can be comprised of multiple smaller (e.g., 4 k) pages. The size of the large pages just needs to exceed that of the smaller pages so that smaller pages can comprise a larger page. (The examples of 1M for a large frame and 4 k for a small frame are provided for illustrative purposes only and not to suggest any limitations). All the small pages belong to the same guest when there are no holes in the pages (meaning that the ownership is consistent across the whole page or frame) so there can be no cross communication between secure guests. Second, all these small pages that comprise the host large frame (which is to be used to back a secure guest) are mapped from one single large guest frame. The pages are not spliced from different large frames as this could create both security and processing challenges. Third, the small pages that comprise the large frame have the same offset in the guest and in the host so that there is no shuffling of guest pages in the large frames. The presence of these three properties enables secure execution of the secure guest and if any of these properties does not exist in a large frame to be assigned to secure guest, the security guarantees of secure execution would be violated so that large frame cannot be used to back a secure guest.

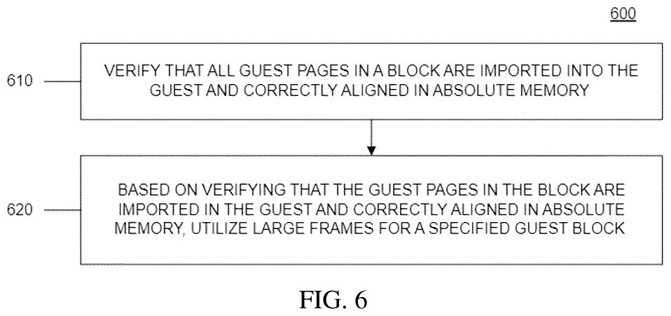

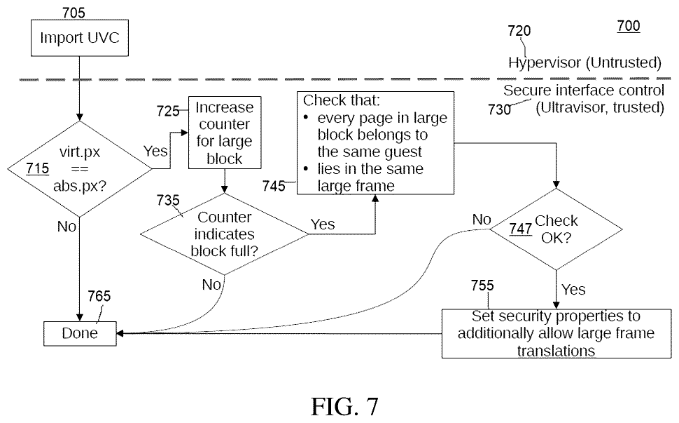

As discussed earlier, enabling the backing of a secure guest with a large frame includes a secure interface control 530 (e.g., an Ultravisor comprising millicode and/or firmware) maintaining a table and/or other value storage structure that includes an entry for each large frame that includes a counter which indicates that that every small page comprising a large frame belong to the same guest. Provided that all the guest pages in the frame (which will be backed by the host) are imported into the guest, correctly aligned in absolute memory, and belong to the same secure guest, the secure guest 510 can be backed utilizing the large page. FIGS. 6 and 7 provide workflows 600 700 that include certain of these aspects. FIG. 6 provide a general overview while FIG. 7 provides more detail related to the functionality of the counter in the table or other storage structure, including but not limited to a bitmap.

Referring to FIG. 6, in this workflow 600, backing a secure guest with a large frame includes verifying determining that all guest pages in the frame are imported in the guest and correctly aligned in absolute memory (610). If an attempt is made to map to a large frame when the security properties do not allow for it, the secure interface control will trigger a program interrupt in the host. Based on verifying that the guest pages in the frame are imported in the guest and correctly aligned in absolute memory, the host can utilizes large frames for the specified guest frame (620). Even if large frames are available, in some of these examples, the host can continue to back sure guests with small frames. This process can be considered transparent because although the host can check whether a large page is available for backing a given guest, the host itself (e.g., the hypervisor) can back secure guests when the feature is available in a transparent manner.

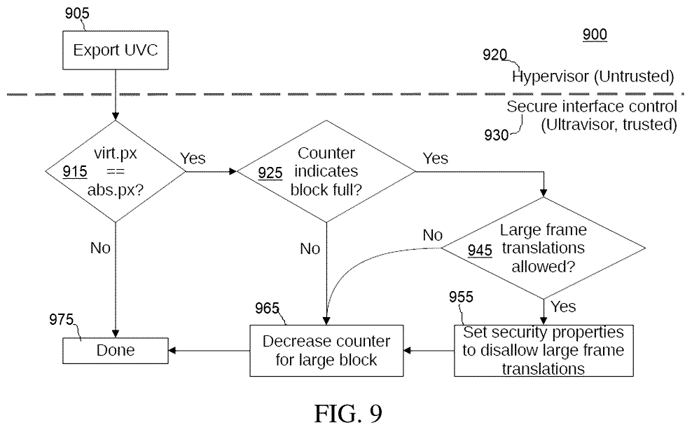

FIG. 700 illustrates a workflow 700 performed by aspects of the examples herein contextualized within a technical architecture. In the examples herein, the host (e.g., hypervisor 720) communicates with the secure interface control 730, via various calls. One such interface or call is an import call or Import UVC. As aforementioned, the secure interface control 730 enables (and disables) functionality enabling a host to back a secure guest with a large page in a manner that is transparent to the guest and to the host memory management. The Import UVC is a standard communication between a hypervisor 720 to a secure interface control 730. As will be illustrated in FIG. 7, the secure interface control 730 can enable backing secure guests with large pages at import. Conversely, as will be illustrated later in FIG. 9, the secure interface control 930 (FIG. 9) can disable backing secure guests with large pages at export.

To utilize the counter functionality described herein, the secure interface control 730 maintains, in memory, a counter record for each large page (which could potentially be used by the host to back a guest). For example, the secure interface control 730 can maintain an extra table or other memory structure that includes an entry for each large frame. FIG. 7 illustrates a workflow 700 in which the secure interface control 730 can enable a large page to be used by the host to back secure guests in a manner that is transparent to both the guest and to the host memory management.

Because, as aforementioned, the secure interface control 730 can transparently enable backing of a secure guest with a large page at import, as illustrated in the workflow 700, the secure interface control 730 obtains an import call (e.g., import UVC) from the hypervisor 720, which the secure interface control 730 executes (705). This call is a standard request by the hypervisor 720 to import into memory a page and/or frame to a memory of a secure guest. The secure interface control 730 checks if the page virtual (guest) address matches with the page corresponding absolute (host) address (virt.px==abs.px) (715). Based on determining that there is a match, the secure interface control 730 increases a counter corresponding to a host large frame (corresponding with the absolute host address) (725). The secure interface control 730 determines if the counter indicates that all pages in the host large frame were imported (e.g., the frame is full) (735). Each counter represents a state of a large page. If the counter indicates that all pages have not been imported, the processing by the system can continue, in this case, without any change in functionality to whether a large page can be used to back a secure guest, and the import completes (765). If the counter indicates that all (small) pages have been imported, the secure interface control 730 determines if every page (e.g., all small pages comprising the large page or frame) belongs to the same guest and if every page belongs to the same guest large frame (745). If the criteria is not met (747), the import completes (765) and there is no change in functionality as to whether a large page can be used to back a secure guest (765). Provided the criteria is met (747) (e.g., all pages belong to the same guest and all pages belong to the same guest large frame), the secure interface control 730 enables large frame translations (e.g., by hardware) for the specified frame of guest memory (755) and the import completes (765). To enable this translation, the secure interface control sets a value and associates it with the large frame. For example, the secure interface control 730 can set a bit in a bitmap. Alternatively, or additionally, the secure interface control can make an entry in a table, such as the SEIDT, for either a first page on the large frame or for all pages of the large frame (as in this example, although a large frame can be allocated to a secure guest, the small frames comprising this frame can also be allocated).

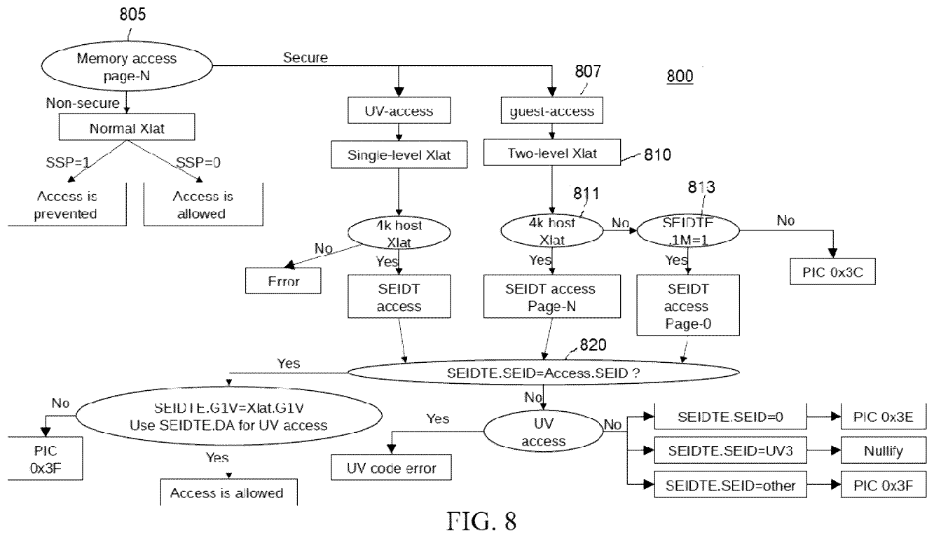

FIG. 8 is a workflow 800 that contextualizes the memory accesses discussed herein in the context of secure and non-secure guest management in a computing environment. For illustrative purposes only and not to suggest any limitations, certain specific elements are referenced herein. Only certain parts of this workflow, which are relevant to the present disclosure, will be reviewed. In the workflow 800, secure execution utilizing host memory 805 by a secure guest 807 is desired. After a two-level translation 810, the access is differentiated as either a small page access (4 k host translation 811) or an access is sought to a large frame, referencing the SEID table (SEIDTE 1M=1 813), as the table is checked to see if the secure guest can be backed by a large frame. At this stage, there can be a translation page size mismatch and the machine reports a program interruption code (PIC) (e.g., PIC 0x3C 814). The PIC 0x3C 814 exception is an exception that is presented when a host is backing a secure guest. The machine (e.g., hardware of the secure control interface) detects the PIC 0x3C after the host has mapped the backing page with a large page and in response to this the host (e.g., hypervisor) knows to import the entire large page. Generally, a hypervisor can map backing storage without knowing if a guest is secure or not, but only if the guest is secure will the PIC 0x3C be presented. By reporting this interruption code, the secure control interface informs the hypervisor (host) of a size mismatch. However, based on receiving this PIC, and hence knowing that the guest is secure, the host can seek a different avenue to enable it to back this secure guest with a large page. Thus, once the machine, through secure interface control, informs the hypervisor of page size mismatch, to back the secure guest with a large page, the host can import the rest of the small pages that comprise the large page (e.g., all small pages in a large frame are imported for same VM, page index matches, etc.) or use small pages instead.

As discussed in FIG. 7, to enable large frame translations, the secure interface control 730 sets a value and associates it with the large frame, which can include a bit in a bitmap or an entry in a table, such as the SEIDT, for either a small frame on the large frame or for all small frames of the large frame (as in this example, although a large frame can be allocated to a secure guest, the small frames comprising this frame can also be allocated). In this example, the bit was set by the secure interface control upon checking that a counter indicates that the large page had been imported (e.g., all pages comprising the page) and the secure interface control determines that every page in the large frame belongs to the same guest and that each page lies in the same large frame. Beyond a designation in a table or a bitmap, there can be other security rules or factors that can affect the decision of a secure interface control to enable a hypervisor to back a secure guest with a large frame. However, the memory access determinations described herein are depicted in FIG. 8.

As discussed earlier, while the secure interface control transparently enables large frame translations for secure guests at import, it transparently disables large frame translations for secure guests at export. In some examples herein, a frame can be broken, a large frame that was formerly available to back a secure guest, based on a host exporting a page from the memory of a secure guest. In some examples, the host initiates an export by issuing an Export UVC call, which is issued by a host so that the host can claim a page back. At export, the secure interface control can break a frame by changing the properties of a small frame belonging to a verified large frame (a large frame that the secure interface control determined could be utilized by the host to back a secure guest). Once a verified frame is broken, it cannot be used anymore to back the large guest frame that it was being used to back. As the methods described herein rely on the whole of a large frame being imported and having common ownership, the large frame, once it is broken, could no longer be utilized by the host to back the secure guest. However, small frame could be utilized to translate the guest memory (e.g., 1M of guest memory or whatever amount was backed by the large frame as large frames or pages can be smaller or larger than 1M).

FIG. 9 illustrates a workflow 900 that includes the secure interface control disabling the use of a large frame for backing a secure guest, e.g., breaking the verified frame, which like FIG. 8 has been contextualized in a technical environment. Parts of this workflow 900 mirror those of the workflow 700 of FIG. 7 in that the same counter is utilized. A host issues an export call so that the host can claim a page back and as illustrated in FIG. 9, in some cases, at export, the secure interface control will break a frame. After an export, a verified large frame may no longer meet the criteria that caused the secure interface control to verify this frame for use in backing a secure guest. The secure interface control 930 can change the security properties of a small page or frame that belong to a large frame and can change the page index (offset) and the value of the counter associated with the large frame when small pages are removed (e.g., exported or otherwise reclaimed). When the page or frame no longer belongs (in its entirety) to the secure guest upon execution of the export, the secure interface control 930 changes the counter to reflect that.

Referring to FIG. 9, the host, hypervisor 920 and the secure interface control 930 communicate via calls (e.g., interfaces). In some examples, the call is an Export UVC. The call seeks to initiate an export of a page, a conversion of the page from secure storage of the secure interface control 930. As illustrated in the workflow 900, the secure interface control 930 obtains a call (e.g., export UVC) from the hypervisor 920, which the secure interface control 930 executes (905). The host does not enable or disable large page translation for a secure guest, but the latter can occur at export. This call is a request by the hypervisor 920 to export a page and/or frame from secure storage. At export, the secure interface control 930 can transparently (to the guest and host memory management) change the security properties of verified large frames. To that end, the secure interface control 930 checks if the page virtual (guest) address matches with the page corresponding absolute (host) address (virt.px==abs.px) (915). Based on determining that there is a match, the secure interface control 930 can decrease the counter corresponding to a host large frame (corresponding with the absolute host address). The secure interface control 930 determines if the counter indicates that all pages in the host large frame were imported (e.g., the block is full) (925). If the counter indicates that all pages had not been imported (meaning that the counter indicates that the block is not full), the secure interface control 930 decreases the counter for the large frame (965) at export completion (975). Because the counter was not full even before the counter was decreased, the large frame relevant to the counter was not formerly verified so making a counter change does not break a frame. Both before and after the secure interface control 930 executed the call, the secure interface control 930 had not set security properties to allow translation of this large frame.

If the counter indicates that all pages of a large frame were imported (meaning that the counter indicates that the block is full), the secure interface control 930 then determines if large frame translations were allowed (the full counter can be one of a number of security protocols that the secure interface control 930 can evaluate when initially enabling translation of the large frame) (945). Whether translations were allowed can be indicated with various types of indicators that the secure interface control 930 would have generated, updated, stored, etc. (e.g., a bit in a bitmap an entry in a table, such as the SEIDT, for either a first small frame or page in the large frame or for all small frames or pages of the large frame). Hence the secure control interface 930 can check for this bit, value, or flag when determining if large frame translations were allowed. If translations were not allowed, the secure interface control 930 decreases the counter value (to reflect exporting the requested page) (965), which will not affect the security properties of the frame because the properties were not set to allow translation. Thus, at completion of the export (975), the secure interface control 930 does not change security properties related to a page. If translations were allowed, the secure interface control 930 sets security properties to disallow large frame translations (955) and decreases the counter value (to reflect exporting the requested page) (965). Thus, at the completion of the export (975), a frame had been broken. To set the security properties to disallow translation, the secure interface control 930 clears an indicator that it had set to allow translation. For example, the secure interface control 930 can clear the bit it set in a bitmap. Alternatively, or additionally, the secure interface control can clear or update an entry in a table, such as the SEIDT, for either a first small page or frame on the large frame or for all small pages or frames of the large frame. In some examples, when the host (hypervisor 920) does anything that changes the security properties, the security interface control 930 can remove the bit and no further modifications are needed to disallow usage of the associated large page in backing secure guests.

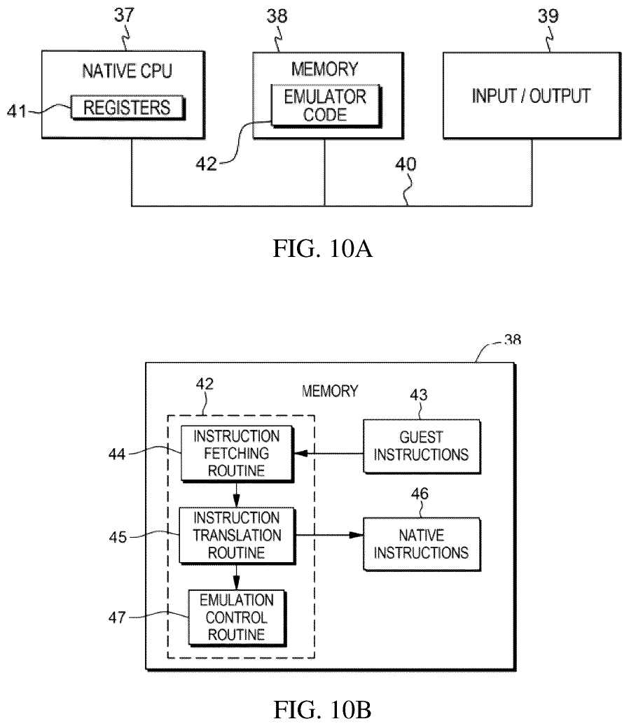

Although one or more examples of a computing environment to incorporate and use one or more aspects of the present disclosure are described herein, FIGS. 10A-10B depict another embodiment of a computing environment to incorporate and use one or more aspects of the present disclosure.

Referring, initially, to FIG. 10A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 10B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

An example instruction that may be emulated is a call from a host to a secure interface control, such as those discussed herein, in accordance with one or more aspects of the present disclosure. Other instructions are also possible.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement control mode processing and/or to perform one or more other aspects of the present disclosure. Software and hardware performance is improved by eliminating extra code and executing time and preventing errors (e.g., for not initializing the unused fields with zeros).

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
enabling host translation for a large page for a given block of memory of a secure guest, the enabling comprising:
executing, in a trusted computing environment, a call from a host to import a page to a memory of the secure guest, wherein the secure guest is managed by the host in an untrusted computing environment;
based on executing the import, determining that a page virtual address matches a page corresponding absolute address;
based on determining that there is a match, increasing a counter associated with the large page, wherein the large page corresponds to the page corresponding absolute address of a small page being imported, wherein the counter indicates a number of small pages comprising the large page imported to the memory of guests managed by the host;
determining that the counter indicates that all the small pages comprising the large page were imported;
based on determining that the counter indicates that all the small pages comprising the large page were imported, determining that all the small pages comprising the large page meet pre-defined security requirements; and
based on determining that all the small pages comprising the large page meet the pre-defined security requirements, enabling host translation for the large page for the given block of memory of the secure guest.

2. The computer program product of claim 1, wherein the secure guest comprises a virtual machine.

3. The computer program product of claim 1, wherein the host comprises a hypervisor.

4. The computer program product of claim 1, the computer operations further comprising:
storing in a computing element, a designation identifying the large page as being enabled for the translation.

5. The computer program product of claim 4, wherein the computing element is selected from the group consisting of: a bitmap and a table.

6. The computer program product of claim 4, the computer operations further comprising:
during runtime of an additional secure guest, checking a designation for another page to identify whether the other page is enabled for use as a large page for host translation for the given block of memory of the additional secure guest;
based on identifying that the other page is not enabled, generating an exception to inform the host of a page mismatch.

7. The computer program product of claim 6, the computer operations comprising:
obtaining, from the host, one or more requests to import each small page comprising the other page to a memory of the additional secure guest for use as the large page for host translation for the given block of memory of the additional secure guest.

8. The computer program product of claim 1, wherein the translation for the large page for the given block of memory of the secure guest is performed by hardware in the trusted computing environment.

9. The computer program product of claim 1, wherein determining that all small pages comprising the large page and the large page meet pre-defined security requirements comprises:
for each small page of the large page:
determining that the page is owned by a common guest owner with all other small pages of the large page; and
determining that the page is located within a common large page.

10. The computer program product of claim 1, the computer operations further comprising:
maintaining, in a trusted computing environment, an entry for each large page of memory, wherein for each large page, the entry comprises the counter.

11. The computer program product of claim 1, the computer operations further comprising:
executing a call from the host to export a given small page of the small pages comprising the large page;
determining that a page virtual address for the given small page matches a page corresponding absolute address for the given small page;
determining if all the small pages comprising the large page were imported; and
based on determining that all the small pages comprising the large page were not imported, decreasing the counter to reflect exporting the given small page.

12. The computer program product of claim 1, the computer operations further comprising:
executing a call from the host to export a given small page of the small pages comprising the large page;
determining that a page virtual address for the given small page matches a page corresponding absolute address for the given small page;
determining if all the small pages comprising the large page were imported; and
based on determining that all the small pages comprising the large page were imported, decreasing the counter to reflect exporting the given small page and disabling host translation for the large page for the given block of memory of the secure guest.

13. The computer program product of claim 12, wherein disabling host translation for the large page for the given block of memory of the secure guest comprises updating, in a computing element, a designation associated with the large page.

14. A computer system comprising:
at least one computing device;
a set of one or more computer-readable storage media; and
program instructions, collectively stored in the set of one or more computer-readable storage media, for causing the at least one computing device to perform computer operations including:
enabling host translation for a large page for a given block of memory of a secure guest, the enabling comprising:
executing, in a trusted computing environment, a call from a host to import a page to a memory of the secure guest, wherein the secure guest is managed by the host in an untrusted computing environment;
based on executing the import, determining that a page virtual address matches a page corresponding absolute address;
based on determining that there is a match, increasing a counter associated with the large page, wherein the large page corresponds to the page corresponding absolute address of a small page being imported, wherein the counter indicates a number of small pages comprising the large page imported to the memory of guests managed by the host;
determining that the counter indicates that all the small pages comprising the large page were imported;
based on determining that the counter indicates that all the small pages comprising the large page were imported, determining that all the small pages comprising the large page meet pre-defined security requirements; and
based on determining that all the small pages comprising the large page meet the pre-defined security requirements, enabling host translation for the large page for the given block of memory of the secure guest.

15. The computer system of claim 14, wherein the secure guest comprises a virtual machine.

16. The computer system of claim 14, wherein the host comprises a hypervisor.

17. The computer system of claim 14, the computer operations further comprising:
storing in a computing element, a designation identifying the large page as being enabled for the translation.

18. The computer system of claim 17, wherein the computing element is selected from the group consisting of: a bitmap and a table.

19. The computer system of claim 17, the computer operations further comprising:
during runtime of an additional secure guest, checking a designation for another page to identify whether the other page is enabled for use as a large page for host translation for the given block of memory of the additional secure guest;
based on identifying that the other page is not enabled, generating an exception to inform the host of a page mismatch.

20. The computer system of claim 19, the computer operations comprising:
obtaining, from the host, one or more requests to import each small page comprising the corresponding large page.

21. The computer system of claim 14, wherein the translation for the large page for the given block of memory of the secure guest is performed by hardware in trusted computing environment.

22. The computer system of claim 14, wherein determining that all small pages comprising the large page and the large page meet pre-defined security requirements comprises:
for each small page of the large page:
determining that the page has the same guest owner as all other small pages of the large page; and
determining that the page is located within a common large page.

23. The computer system of claim 14, the computer operations further comprising:
maintaining, in a trusted computing environment, an entry for each large page of memory, wherein for each large page, the entry comprises the counter.

24. The computer system of claim 14, the computer operations further comprising:
executing a call from the host to export a given small page of the small pages comprising the large page;
determining that a page virtual address for the given small page matches a page corresponding absolute address for the given small page;
determining if all the small pages comprising the large page were imported; and
based on determining that all the small pages comprising the large page were imported, decreasing the counter to reflect exporting the given small page and disabling host translation for the large page for the given block of memory of the secure guest.

25. A computer-implemented method comprising:
requesting execution of an instruction to perform an action defined by the instruction, wherein the executing the instruction includes:
enabling host translation for a large page for a given block of memory of a secure guest, the enabling comprising:
executing, in a trusted computing environment, a call from a host to import a page to a memory of the secure guest, wherein the secure guest is managed by the host in an untrusted computing environment;
based on executing the import, determining that a page virtual address matches a page corresponding absolute address;
based on determining that there is a match, increasing a counter associated with the large page, wherein the large page corresponds to the page corresponding absolute address of a small page being imported, wherein the counter indicates a number of small pages comprising the large page imported to the memory of guests managed by the host;
determining that the counter indicates that all the small pages comprising the large page were imported;
based on determining that the counter indicates that all the small pages comprising the large page were imported, determining that all the small pages comprising the large page meet pre-defined security requirements; and
based on determining that all the small pages comprising the large page meet the pre-defined security requirements, enabling host translation for the large page for the given block of memory of the secure guest.
